(19) United States
(12) Patent Application Publication
(10) Pub. No.: US 2026/0196930 A1
(43) Pub. Date: Jul. 9, 2026

(54) POWER CONVERTER CAPABLE OF HIGH-SPEED SWITCHING

(71) Applicant: URIMTS CO.,LTD., Gimpo-si (KR)

(72) Inventor: Jae Moon LEE, Anyang-si (KR)

(73) Assignee: URIMTS CO.,LTD., Gimpo-si, GG (KR)

(21) Appl. No.: 18/870,037

(22) PCT Filed: May 19, 2023
(86) PCT No.: PCT/KR2023/006847

§ 371 Date: Jul. 9, 2025

(30) Foreign Application Priority Data
Jun. 17, 2022 (KR) 10-2022-0074314

(51) Int. Cl. H02M 3/158; H02M 1/44

(52) U.S. Cl. CPC H02M 3/158; H02M 1/44

(57) ABSTRACT

A power conversion device includes a power stage which includes N (N is a natural number equal to or more than 3) upper switches arranged in parallel with each other and N lower switches arranged in parallel with each other and generates an output voltage having a voltage level different from that of an input voltage according to on and off of the upper switches and the lower switches, and a controller which generates gate control signals for the upper switches and the lower switches, alternately turns on and off the upper switches and the lower switches by using the gate control signals, and controls the gate control signals so that the respective upper switches are turned on at different time points and the respective lower switches are turned on at different time points in every control period.

### TECHNICAL FIELD

The present embodiment relates to a power conversion device.

### BACKGROUND ART

A power conversion device known as a switched mode power supply (SMPS) converts power by controlling an on/off time ratio of switches. Most large-scale power conversion devices used today, as well as SMPS, are in the form of switching regulators that convert power by controlling the on/off time ratio of switches.

Power conversion devices in the form of switching regulators can be applied to a variety of applications, for example, the power conversion devices can be applied to devices that convert solar power into alternating current power and devices that provide power to electric vehicles.

The amount of power that a power conversion device can handle in each device can vary. For example, a device that provides power to a laptop may have a small processing power amount, while a device that provides power to an electric car may have a large processing power amount.

Meanwhile, switches used in power conversion devices may have certain limitations on their switching frequencies. These limitations are usually determined by the size of the processing power amount of the power conversion device. In general, the larger the power processing capacity of the power conversion device, the lower the switching frequency of the switches may need to be controlled.

Switches have a limit to an amount of generated heat, and as the processing power amount and switching frequency increase, the amount of generated heat also increases, and thus, when the processing power amount increases, the switching frequency may need to be controlled to a lower level.

Increasing the switching frequency of switches in the power conversion device can have various advantages. For example, increasing the switching frequency of switches in a power conversion device can reduce ripple that appears in an output voltage. Accordingly, a size of an output capacitor or a size of an inductor can be reduced. In addition, in driving an electric vehicle motor, increasing the switching frequency can have the advantage of increasing the motor speed.

Despite these advantages of increasing the switching frequency, it has been difficult to increase the switching frequency in conventional technologies due to the problems described above.

### DETAILED DESCRIPTION OF THE INVENTION

### Technical Problem

Against this background, in one aspect, the purpose of the present embodiment is to provide a power conversion device capable of high-speed switching. In another aspect, the purpose of the present embodiment is to provide a power conversion device capable of minimizing electro-magnetic interference (EMI). In yet another aspect, the purpose of the present embodiment is to provide a power conversion device capable of improving cooling performance by distributing power capacity to each switch.

### Technical Solution

In order to achieve the above-described objects, according to one embodiment, a power conversion device including: a power stage which includes N (N is a natural number equal to or more than 3) upper switches arranged in parallel with each other and N lower switches arranged in parallel with each other and generates an output voltage having a voltage level different from that of an input voltage according to on and off of the upper switches and the lower switches; and a controller which generates gate control signals for the upper switches and the lower switches, alternately turns on and off the upper switches and the lower switches by using the gate control signals, and controls the gate control signals so that the respective upper switches are turned on at different time points and the respective lower switches are turned on at different time points in every control period.

One of the upper switches and one of the lower switches may be connected in series to form an arm, and switches arranged on an upper side of N arms packaged in one power semiconductor module may constitute the upper switches, and switches arranged on a lower side of the arms may constitute the lower switches.

When a time period during which one of the upper switches is turned on and subsequently one of the lower switches is turned on is referred to as a switching period, the controller may control the gate control signals so that the upper switch and the lower switch of at least one arm of the N arms are turned on at different switching periods.

Three arms may be arranged in the power semiconductor module, and the upper switches and the lower switches of two arms may be turned on at different switching periods, and the upper switches and the lower switches of the remaining one arm may be turned on at the same switching period.

The power semiconductor module may be formed with an upper node connected to a high voltage input terminal, a lower node connected to a low voltage input terminal, and an intermediate node connected to output terminals, and one side of the upper switches may be commonly connected to the upper node, one side of the lower switches may be commonly connected to the lower node, and the intermediate nodes to which the other side of the upper switches and the other side of the lower switches are connected may be connected to each other outside the output terminals.

### Effects of the Invention

As described above, according to the present embodiment, switching frequencies of switches in the power conversion device can be increased and high-speed switching can be performed. In addition, according to the present embodiment, a power conversion device in which electro-magnetic interference (EMI) can be minimized even in a high-speed switching environment can be provided.

Moreover, according to the present embodiment, since the amount of power processed by each switch is reduced, the heat generation of each switch can be reduced. Since the amount of generated heat of each switch is reduced, cooling performance of the power conversion device can also be improved.

### BRIEF DESCRIPTION OF THE DRAWINGS

FIG. 1 is a configuration diagram of a power conversion device according to one embodiment.

FIG. 2 is a configuration diagram of a power stage according to one embodiment.

FIG. 3 is a diagram illustrating a waveform of an inductor current in FIG. 2.

FIG. 4 is a diagram for explaining a switching period and the limitation of the switching period.

FIG. 5 is a circuit configuration diagram of a power semiconductor module according to one embodiment.

FIG. 6 is a diagram illustrating waveforms of gate control signals in FIG. 5.

FIG. 7 is a diagram illustrating a first example of an ON order of each switch in the power semiconductor module according to one embodiment.

FIG. 8 is a diagram illustrating a second example of the ON order of each switch in the power semiconductor module according to one embodiment.

### MODE FOR IMPLEMENTING THE INVENTION

Hereinafter, some embodiments of the present disclosure will be described in detail with reference to exemplary drawings. When adding reference numerals to components in each drawing, it should be noted that the same components are given the same numerals as much as possible even if they are illustrated in different drawings. In addition, when describing the present disclosure, if it is determined that a specific description of a related known configuration or function may obscure the gist of the present disclosure, the detailed description thereof will be omitted.

Moreover, in describing components of the present disclosure, terms such as first, second, A, B, (a), (b), and the like may be used. These terms are only intended to distinguish the components from other components, and the nature, order, or sequence of the components are not limited by the terms. When it is described that a component is “connected,” “coupled,” or “joined” to another component, it should be understood that the component may be directly connected or joined to the other component, but still another component may also be “connected,” “coupled,” or “joined” between respective components.

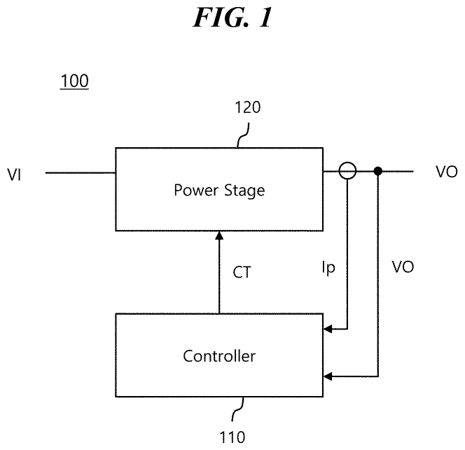

FIG. 1 is a configuration diagram of a power conversion device according to one embodiment.

Referring to FIG. 1, a power conversion device 100 may include a power stage 120, a controller 110, or the like.

The power stage 120 may convert an input voltage VI into an output voltage VO having a different voltage level. For example, the power stage 120 may convert the input voltage VI having a low voltage level into an output voltage VO having a high voltage level. Moreover, the power stage 120 may convert the input voltage VI having a high voltage level into an output voltage VO having a low voltage level. The former is also called a step-up converter. Moreover, the latter is also called a step-down converter.

The power stage 120 includes switches, and may convert input voltage VI into output voltage VO by controlling the on/off of these switches. The switches are also called power semiconductors, and representative examples include a metal oxide semiconductor field effect transistor (MOSFET), an insulated gate bipolar transistor (IGBT), or the like.

The controller 110 may control the on/off of the switches by transmitting a gate control signal CT to the power stage 120. Each switch may be turned on and off more than once within a control period. A ratio of the time that one switch is turned on within the control period is also called duty, and a ratio of the output voltage VO to the input voltage VI of the power stage 120 may be determined by this duty.

The controller 110 may regulate the output voltage VO of the power stage 120 or regulate one current Ip of the power stage 120. The controller 110 may sense the output voltage VO of the power stage 120 and control the gate control signal CT so that the output voltage VO corresponds to the regulation voltage (value). Alternatively, the controller 110 may control the gate control signal CT so that the one current Ip of the power stage 120 corresponds to the regulation current (value). Here, the heat current may be, for example, an inductor current in the power stage 120 or an output current.

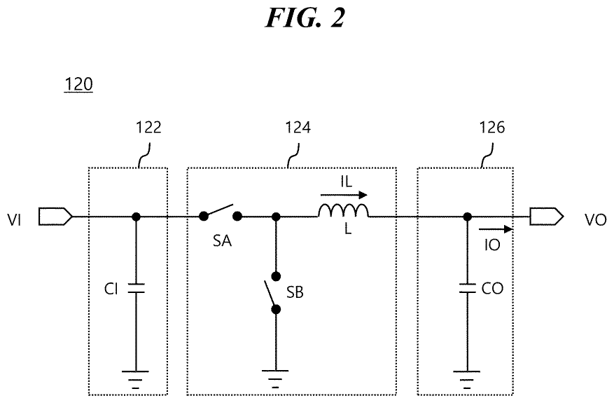

FIG. 2 is a configuration diagram of a power stage according to one embodiment.

Referring to FIG. 2, the power stage 120 may include an input circuit 122, a power conversion circuit 124, an output circuit 126, and the like.

The input circuit 122 may remove noise components included in the input voltage VI. In addition, the input circuit 122 may adjust an input impedance of the power stage 120 as viewed from a side supplying the input voltage VI. The input circuit 122 can include an input capacitor CI for this purpose. The input capacitor CI may perform the function of removing noise components included in the input voltage VI and the function of adjusting the input impedance.

In terms of a connection relationship, input voltage VI may be supplied to one side of the input capacitor CI and low voltage may be supplied to the other side of the input capacitor CI.

The output circuit 126 may remove noise components included in the output voltage VO. In addition, the output circuit 126 may adjust an output impedance of the power stage 120 as viewed from a side receiving the output voltage VO. The output circuit 126 can include an output capacitor CO for this purpose. The output capacitor CO may perform the function of removing noise components included in the output voltage VO and may perform the function of adjusting the output impedance.

In terms of a connection relationship, the output voltage VO may be supplied to one side of the output capacitor CO and a low voltage may be supplied to the other side of the output capacitor CO.

The power conversion circuit 124 may convert the input voltage VI into the output voltage VO.

The power conversion circuit 124 includes a first switch SA and a second switch SB, and may include an inductor L. The power conversion circuit 124 may store electric energy in the inductor L by turning the first switch SA and the second switch SB on and off, and may transfer the electric energy stored in the inductor L to the output capacitor CO.

The connection relationship among the first switch SA, the second switch SB, and the inductor L may vary. The connection relationship illustrated in FIG. 2 is a connection relationship in a buck converter, but the present embodiment is not limited thereto, and various forms of connection relationships such as a boost converter, a flyback converter, a buck-boost converter, and a cook converter may all be applied. For convenience of explanation, the following description will focus on the connection relationship illustrated in FIG. 2.

In the power conversion circuit 124, the input voltage VI may be supplied to one side of the first switch SA. Moreover, the other side of the first switch SA may be connected to one side of the inductor L and one side of the second switch SB.

A low voltage may be supplied to the other side of the second switch SB. Here, the low voltage is a voltage lower than the input voltage VI and the output voltage VO, and may be the ground voltage.

The other side of the inductor L may be connected to the output capacitor CO.

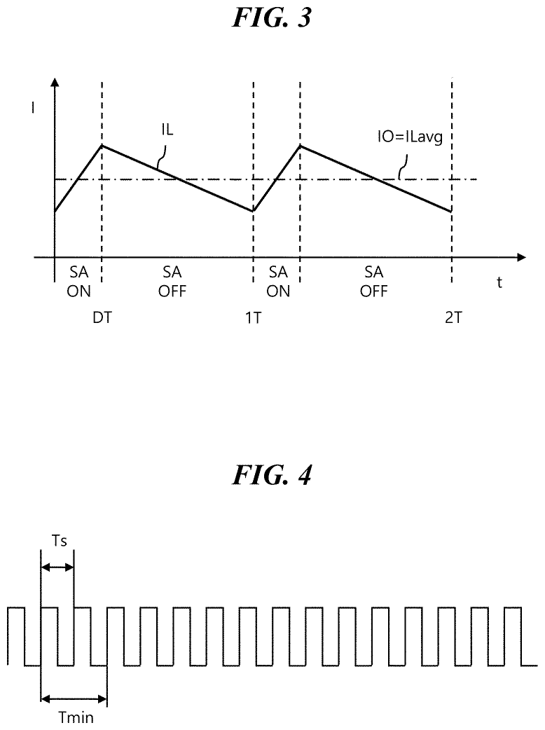

FIG. 3 is a diagram illustrating a waveform of the inductor current in FIG. 2.

Referring to FIG. 3, the first switch SA may be turned on in a first section SA ON of control periods 1T and 2T, and the first switch SB may be turned off in the second section SA OFF. In addition, the second switch SB may be turned off in the first section SA ON of the control periods 1T and 2T, and the second switch SB may be turned on in the second section SA OFF.

Referring to FIGS. 2 and 3 together, in the first section SA ON, the first switch SA is turned on and the second switch SB is turned off, so that the input voltage VI may be supplied to one side of the inductor L and the output voltage VO may be supplied to the other side of the inductor L. In this case, when the input voltage VI is higher than the output voltage VO, electric energy is accumulated in the inductor L and a current IL of the inductor L increases.

In the second section SA OFF, the first switch SA is turned off and the second switch SB is turned on, so that a low voltage (for example, a ground voltage) may be supplied to one side of the inductor L and the output voltage VO may be supplied to the other side of the inductor L. In this case, the electric energy stored in the inductor L is released and the current IL of the inductor L decreases.

In the control periods 1T and 2T, the inductor current IL becomes balanced. For example, the inductor current IL decreases in the second section SA OFF as much as it increases in the first section SA ON, and an average value ILavg of the inductor current IL in each of the control periods 1T and 2T may be maintained constant.

In the structure of FIG. 2, the average value ILavg of the inductor current IL may be equal to the output current IL.

When a ratio of the first section SA ON in the control periods 1T and 2T is called a duty D, the length of the first section SA ON may be calculated as DT. In addition, the voltage level of the output voltage VO may be determined according to the size of the duty D.

FIG. 4 is a diagram for explaining a switching period and the limitation of the switching period.

In FIG. 4, Ts represents one switching period. Here, the switching period represents the time from when one current path connected to a switch is turned on (connected) to when the one current path is turned off (disconnected) and then turned on again, indicating a period of repeating on and off. In addition, the control period represents the time from when one switch arranged in the current path is turned on (on control) to when one switch is turned off (off control) and then turned on again.

When the control period includes only one switching period, the control period may be identical to the switching period. However, the control period may include more than one switching period.

Meanwhile, when the control period and switching period are the same, there may be certain limitations on the switching period depending on the characteristics of the switches. For example, there may be a minimum switching period time Tmin for each switch.

The minimum time Tmin of the switching period may be determined by the physical characteristics of the switch. When the switching period is short, the amount of generated heat may increase, but the amount of generated heat may be limited depending on the physical characteristics of the switch, and when a limit value of the amount of generated heat is low, the minimum time Tmin of the switching period may be longer.

However, depending on the application, there are cases where the switching period should be shortened. For example, when a physical size of the inductor should be reduced, the switching period should be shortened. Alternatively, when the ripple in the output voltage should be reduced, the switching period should be shortened. Another reason is that in the case of inverters used to drive electric vehicle motors, the switching period should be shortened to increase the revolutions per minute (RPM).

In one embodiment, in a situation where the control period and the switching period are the same and the switching period is limited due to the physical characteristics of the switches, a structure or method is proposed that can have the same effect as shortening the switching period by making the control period and the switching period different.

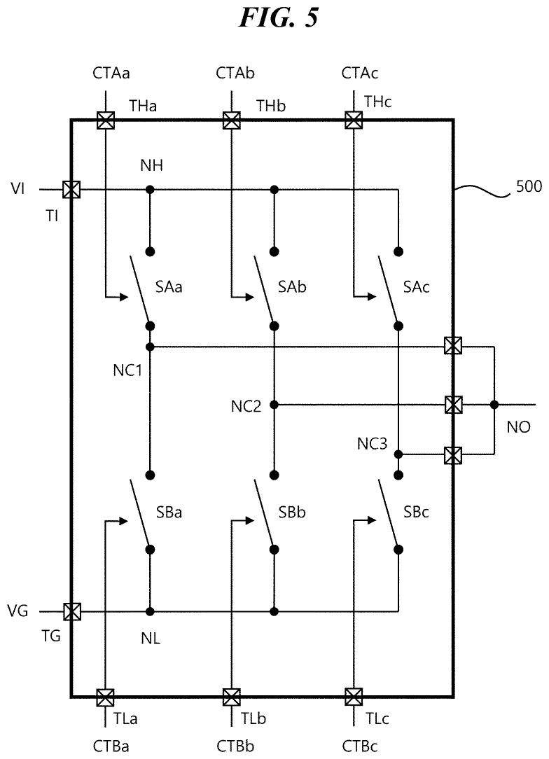

FIG. 5 is a circuit configuration diagram of a power semiconductor module according to one embodiment.

Referring to FIG. 5, a power semiconductor module 500 may include upper switches SAa, SAb, and SAc and lower switches SBa, SBb, and SBc.

The power semiconductor module 500 packages switches SAa, SAb, SAc, SBa, SBb, and SBc and may include not only the switches SAa, SAb, SAc, SBa, SBb, and SBc but also wires connecting the switches SAa, SAb, SAc, SBa, SBb, and SBc and insulating material or protective material for insulating and protecting the switches SAa, SAb, SAc, SBa, SBb, and SBc.

The power semiconductor module 500 may be used to replace the first switch and the second switch in the power conversion circuit described with reference to FIG. 2.

For example, in the power conversion circuit described with reference to FIG. 2, the first switch may be replaced with the upper switches SAa, SAb, and SAc, and the second switch may be replaced with the lower switches SBa, SBb, and SBc.

Within a power semiconductor module 500, N (N is a natural number equal to or more than 3) upper switches SAa, SAb, and SAc may be arranged in parallel with each other.

The upper switches SAa, SAb, and SAc can be electrically connected in parallel. One side of the upper switches SAa, SAb, and SAc may be connected to an upper node NH. Moreover, the other side of the upper switches SAa, SAb, and SAc may be connected to intermediate nodes NC1, NC2, and NC3. The intermediate nodes NC1, NC2, and NC3 may be electrically connected inside the power semiconductor module 500 and may be electrically connected through an output node NO formed outside the output terminal of the power semiconductor module 500.

Within the power semiconductor module 500, N lower switches SBa, SBb, and SBc may be arranged in parallel with each other.

The lower switches SBa, SBb, and SBc can be electrically connected in parallel. One side of the lower switches SBa, SBb, and SBc may be connected to a lower node NL. Moreover, the other side of the lower switches SBa, SBb, and SBc may be connected to the intermediate nodes NC1, NC2, and NC3. The intermediate nodes NC1, NC2, and NC3 may be electrically connected inside the power semiconductor module 500 and may be electrically connected through the output node NO formed outside the output terminal of the power semiconductor module 500.

The upper node NH can be connected to a high voltage input terminal TI, and the input voltage VI may be supplied to the high voltage input terminal TI.

A lower node NG may be connected to a low voltage input terminal TG, and a low voltage VG may be supplied to the low voltage input terminal TG, and the low voltage VG may be a ground voltage.

One of the upper switches SAa, SAb, and SAc and one of the lower switches SBa, SBb, and SBc may be connected in series to form an arm.

The switches arranged on the upper side of the N arms packaged in one power semiconductor module 500 may constitute the upper switches SAa, SAb, and SAc, and the switches arranged on the lower side of the arms may constitute the lower switches SBa, SBb, and SBc.

Gate control signals CTAa, CTAb, CTAc, CTBa, CTBb, and CTBc may be supplied through gate control signal terminals THa, THb, THc, TLa, TLb, and TLc.

The controller may generate gate control signals CTAa, CTAb, CTAc, CTBa, CTBb, and CTBc for the upper switches SAa, SAb, and SAc and lower switches SBa, SBb, and SBc, and may alternately turn on and off the upper switches SAa, SAb, and SAc and the lower switches SBa, SBb, and SBc using the gate control signals CTAa, CTAb, CTAc, CTBa, CTBb, and CTBc.

Upper gate control signals CTAa, CTAb, and CTAc may be supplied to upper gate control signal terminals THa, THb, and THc, and lower gate control signals CTBa, CTBb, and CTBc can be supplied to lower gate control signal terminals TLa, TLb, and TLc.

Meanwhile, the controller may control the gate control signals so that each of the upper switches SAa, SAb, and SAc turns on at a different time point and each of the lower switches SBa, SBb, and SBc turns on at a different time point in each control period.

As an example, a first upper switch SAa may be turned on at a different time from a second upper switch SAb and a third upper switch SAc, and the second upper switch SAb may be turned on at a different time from the third upper switch SAc and the first upper switch SAa. The on times of the respective upper switches SAa, SAb, and SAc may not overlap with each other.

As another example, a first lower switch SBa may be turned on at a different time than a second lower switch SBb and a third lower switch SBc, and the second lower switch SBb may be turned on at a different time than the third lower switch SBc and the first lower switch SBa. The on times of the respective lower switches SBa, SBb, and SBc may not overlap with each other.

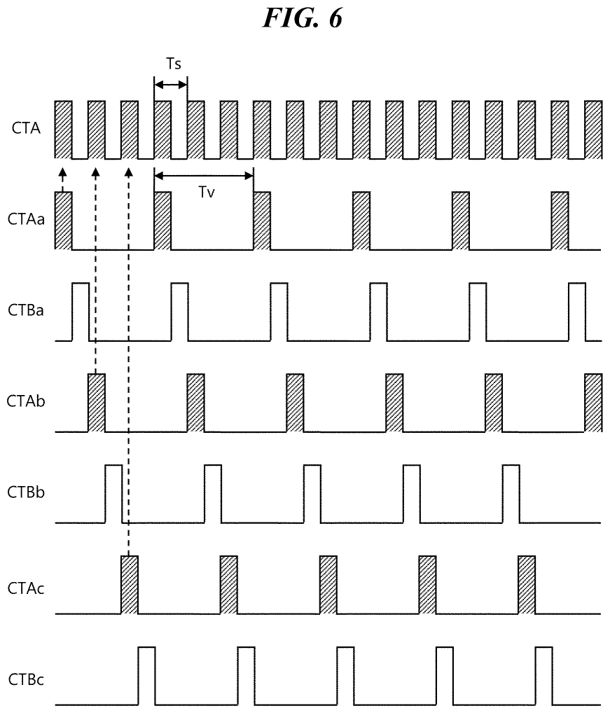

FIG. 6 is a diagram illustrating waveforms of the gate control signals in FIG. 5.

Referring to FIGS. 5 and 6, each of the gate control signals CTAa, CTAb, CTAc, CTBa, CTBb, and CTBc may be turned on and off once per control period Tv. In FIG. 6, it can be understood that the switches SAa, SAb, SAc, SBa, SBb, and SBc are turned on in the high-voltage pulse section of each of the gate control signals CTAa, CTAb, CTAc, CTBa, CTBb, and CTBc and the switches SAa, SAb, SAc, SBa, SBb, and SBc are turned off in the low-voltage section.

The time period during which one of the upper switches SAa, SAb, and SAc is turned on and subsequently one of the lower switches SBa, SBb, and SBc is turned on can be defined as a switching period Ts.

According to gate control signals CTAa, CTAb, CTAc, CTBa, CTBb, and CTBc as in one embodiment, since one of the upper switches SAa, SAb, and SAc and one of the lower switches SBa, SBb, and SBc are alternately turned on, N switching periods Ts appear in the control period Tv. Here, N is the number of upper switches SAa, SAb, and SAc, which may be equal to the number of arms.

When the upper gate control signals CTAa, CTAb, and CTAc overlap with each other, a virtual upper gate control signal CTA as illustrated in FIG. 6 is obtained. According to a control according to an embodiment, a first switch (see SA of FIG. 2) of a power conversion circuit is turned on and off like the virtual upper gate control signal CTA. Similarly, a virtual lower gate control signal (not illustrated) may be confirmed by overlapping the lower gate control signals CTBa, CTBb, and CTBc, and a second switch (see SB of FIG. 2) of a power conversion circuit is turned on and off like a virtual lower gate control signal (not illustrated).

In this way, the physical on-off cycle of each of the switches SAa, SAb, SAc, SBa, SBb, and SBc is equal to the control period Tv, but the switching period Ts confirmed in the power conversion circuit is N times faster. Therefore, the power conversion device according to one embodiment enables high-speed switching even in a situation where there is a physical limit to the switch.

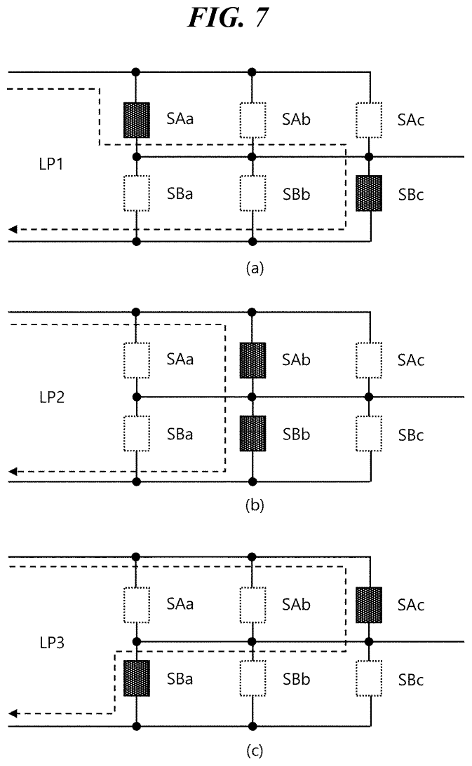

FIG. 7 is a diagram illustrating a first example of an ON order of each switch in the power semiconductor module according to one embodiment.

Referring to FIG. 7, three arms may be arranged within the power semiconductor module. Moreover, the upper switch and the lower switch of two arms may be turned on at different switching periods, and the upper switch and the lower switch of the remaining arm may be turned on at the same switching period.

For example, in the first switching period ((a) of FIG. 7), after the upper switch SAa of the first arm is turned on, the lower switch SBc of the third arm may be turned on. Then, in the second switching period ((b) of FIG. 7), after the upper switch SAb of the second arm is turned on, the lower switch SBb of the second arm may be turned on. Then, in the third switching period ((c) of FIG. 7), after the upper switch SAc of the third arm is turned on, the lower switch SBa of the first arm may be turned on.

In the power semiconductor module, the side to which the input voltage and the low voltage—the ground voltage—are supplied may be one side—the left side in FIG. 7—and the side to which the output voltage is output may be the other side—the right side in FIG. 7. In addition, the first arm may be arranged closest to one side of the power semiconductor module and may be sequentially arranged to the right, so that the Nth arm may be arranged closest to the other side of the power semiconductor module.

In this arrangement, when controlling as in the first example of FIG. 7, widths of the power paths LP1, LP2, and LP3 in each switching period may be substantially the same or very similar. The widths of the power paths LP1, LP2, and LP3 may be a factor in determining the size of the parasitic inductance. Therefore, with the control as in the first example, the effect of uniformly maintaining the size of the parasitic inductance in each switching period can be created.

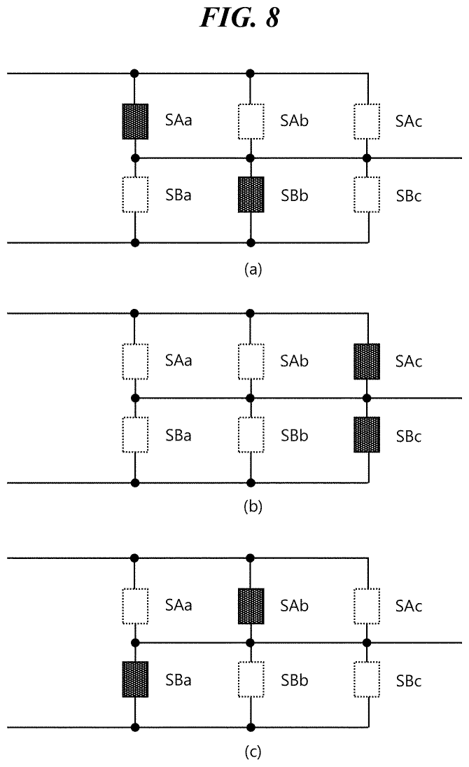

FIG. 8 is a diagram illustrating a second example of the ON order of each switch in the power semiconductor module according to one embodiment.

Referring to FIG. 8, the control period includes N switching periods, and the configuration of each switching period may be different or randomized in each control period.

For example, in the first switching period of the first control period ((a) of FIG. 8), after the upper switch SAa of the first arm is turned on, the lower switch SBb of the second arm may be turned on. Then, in the second switching period ((b) of FIG. 8), after the upper switch SAc of the third arm is turned on, the lower switch SBc of the third arm may be turned on. Then, in the third switching period ((c) of FIG. 8), after the upper switch SAb of the second arm is turned on, the lower switch SBa of the first arm may be turned on.

Moreover, in the second control period, the configuration of each switching period—the switches that are turned on—may be the same as the first example of FIG. 7. Moreover, in the third control period, the configuration of each switching period may be different from the first and second examples.

In the power semiconductor module, the side to which the input voltage and the low voltage—the ground voltage—are supplied may be one side—the left side in FIG. 8—and the side to which the output voltage is output may be the other side—the right side in FIG. 8. In addition, the first arm may be arranged closest to one side of the power semiconductor module and may be sequentially arranged to the right, so that the Nth arm may be arranged closest to the other side of the power semiconductor module.

In this arrangement, when the configuration of the switching period in each control period—the switches that are turned on—is changed, the power paths become random, which can create the effect of reducing electro-magnetic interference (EMI).

As described above, according to this embodiment, the switching frequency of switches in a power conversion device can be increased and high-speed switching can be performed. In addition, according to this embodiment, it is possible to provide the power conversion device in which the EMI can be minimized even in a high-speed switching environment.

Moreover, according to the present embodiment, since the amount of power processed by each switch is reduced, the amount of generated heat of each switch can be reduced. Since the amount of generated heat of each switch is reduced, the cooling performance of the power conversion device can also be improved.

The terms “include,” “comprise,” or “have” as used herein, unless otherwise specifically stated, imply that the corresponding component may be included, and therefore should be construed to include other components rather than to exclude other components. All terms, including technical or scientific terms, unless otherwise defined, have the same meaning as commonly understood by a person of ordinary skill in the art to which the present disclosure pertains. Commonly used terms, such as terms defined in a dictionary, should be interpreted as being consistent with their meaning in the context of the relevant art, and shall not be interpreted in an ideal or overly formal sense, unless expressly defined in the present disclosure.

The above description is merely an illustrative description of the technical idea of the present disclosure, and those skilled in the art will appreciate that various modifications and variations may be made without departing from the essential characteristics of the present disclosure. Accordingly, the embodiments disclosed in the present disclosure are not intended to limit the technical idea of the present disclosure but to explain it, and the scope of the technical idea of the present disclosure is not limited by these embodiments. The protection scope of the present disclosure should be interpreted by the following claims, and all technical ideas within a scope equivalent thereto should be interpreted as being included in the scope of the rights of the present disclosure.

1. A power conversion device comprising:
a power stage which includes N (N is a natural number equal to or more than 3) upper switches arranged in parallel with each other and N lower switches arranged in parallel with each other and generates an output voltage having a voltage level different from that of an input voltage according to on and off of the upper switches and the lower switches; and
a controller which generates gate control signals for the upper switches and the lower switches, alternately turns on and off the upper switches and the lower switches by using the gate control signals, and controls the gate control signals so that the respective upper switches are turned on at different time points and the respective lower switches are turned on at different time points in every control period.

2. The power conversion device of claim 1, wherein one of the upper switches and one of the lower switches are connected in series to form an arm, and
switches arranged on an upper side of N arms packaged in one power semiconductor module constitute the upper switches, and switches arranged on a lower side of the arms constitute the lower switches.

3. The power conversion device of claim 2, wherein when a time period during which one of the upper switches is turned on and subsequently one of the lower switches is turned on is referred to as a switching period,
the controller controls the gate control signals so that the upper switch and the lower switch of at least one arm of the N arms are turned on at different switching periods.

4. The power conversion device of claim 3, wherein three arms are arranged in the power semiconductor module, and
the upper switches and the lower switches of two arms are turned on at different switching periods, and the upper switches and the lower switches of the remaining one arm are turned on at the same switching period.

5. The power conversion device of claim 2, wherein the power semiconductor module is formed with an upper node connected to a high voltage input terminal, a lower node connected to a low voltage input terminal, and an intermediate node connected to output terminals, and
one side of the upper switches is commonly connected to the upper node, one side of the lower switches is commonly connected to the lower node, and the intermediate nodes to which the other side of the upper switches and the other side of the lower switches are connected are connected to each other outside the output terminals.

6. A power conversion device comprising:
a power stage which includes three upper switches arranged in parallel with each other and three lower switches arranged in parallel with each other and generates an output voltage having a voltage level different from that of an input voltage according to on and off of the upper switches and the lower switches; and
a controller which generates gate control signals for the upper switches and the lower switches, alternately turns on and off the upper switches and the lower switches by using the gate control signals, and controls the gate control signals so that the respective upper switches are turned on at different time points and the respective lower switches are turned on at different time points in each control period,
wherein the upper switches and the lower switches are arranged in a power semiconductor module, a high voltage input terminal and a low voltage input terminal are formed in the power semiconductor module, and an upper node connected to the high voltage input terminal and a lower node connected to the lower voltage input terminal are formed in the power semiconductor module,
a first upper switch of the upper switches has one side connected to the upper node and the other side connected to a first intermediate node, a first lower switch of the lower switches has one side connected to the first intermediate node and the other side connected to the lower node, and the first upper switch and the first lower switch form a first arm,
a second upper switch of the upper switches has one side connected to the upper node and the other side connected to a second intermediate node, a second lower switch of the lower switches has one side connected to the second intermediate node and the other side connected to the lower node, and the second upper switch and the second lower switch form a second arm,
a third upper switch of the upper switches has one side connected to the upper node and the other side connected to a third intermediate node, the third lower switch of the lower switches has one side connected to the third intermediate node and the other side connected to the lower node, and the third upper switch and the third lower switch form a third arm,
the first intermediate node, the second intermediate node, and the third intermediate node are electrically connected to each other,
the first arm is arranged closest to one side of the power semiconductor module, the third arm is arranged closest to the other side of the power semiconductor module, and the second arm is arranged between the first arm and the third arm,
when a time period during which one of the upper switches is turned on and subsequently one of the lower switches is turned on is referred to as a switching period,
the controller controls the gate control signals so that the upper switch and the lower switch of the first arm and the third arm are turned on at different switching periods and the upper switch and the lower switch of the second arm are turned on at the same switching period, in each control period.

7. The power conversion device of claim 6, wherein the third lower switch of the third arm is turned on after the first upper switch of the first arm is turned on in a first switching period of one control period, the second lower switch of the second arm is turned on after the second upper switch of the second arm is turned on in a second switching period of the one control period, and the first lower switch of the first arm is turned on after the third upper switch of the third arm is turned on in a third switching period of the one control period.

8. A power conversion device comprising:
a power stage which includes three upper switches arranged in parallel with each other and three lower switches arranged in parallel with each other and generates an output voltage having a voltage level different from that of an input voltage according to on and off of the upper switches and the lower switches; and
a controller which generates gate control signals for the upper switches and the lower switches, alternately turns on and off the upper switches and the lower switches by using the gate control signals, and controls the gate control signals so that the respective upper switches are turned on at different time points and the respective lower switches are turned on at different time points in each control period,
wherein the upper switches and the lower switches are arranged in a power semiconductor module, a high voltage input terminal and a low voltage input terminal are formed in the power semiconductor module, and an upper node connected to the high voltage input terminal and a lower node connected to the lower voltage input terminal are formed in the power semiconductor module,
a first upper switch of the upper switches has one side connected to the upper node and the other side connected to a first intermediate node, a first lower switch of the lower switches has one side connected to the first intermediate node and the other side connected to the lower node, and the first upper switch and the first lower switch form a first arm,
a second upper switch of the upper switches has one side connected to the upper node and the other side connected to a second intermediate node, a second lower switch of the lower switches has one side connected to the second intermediate node and the other side connected to the lower node, and the second upper switch and the second lower switch form a second arm,
a third upper switch of the upper switches has one side connected to the upper node and the other side connected to a third intermediate node, the third lower switch of the lower switches has one side connected to the third intermediate node and the other side connected to the lower node, and the third upper switch and the third lower switch form a third arm,
the first intermediate node, the second intermediate node, and the third intermediate node are electrically connected to each other,
the first arm is arranged closest to one side of the power semiconductor module, the third arm is arranged closest to the other side of the power semiconductor module, and the second arm is arranged between the first arm and the third arm,
when a time period during which one of the upper switches is turned on and subsequently one of the lower switches is turned on is referred to as a switching period,
the controller controls the gate control signals so that a configuration of the upper switch and the lower switch that are turned on in each switching period is randomized in each control period.
